(19) United States
(12) Patent Application Publication
(10) Pub. No.: US 2006/0075424 A1
(43) Pub. Date: Apr. 6, 2006

(54) Import control of content

(75) Inventors: Johan Cornelis Talstra, Eindhoven (NL); Maurice Jerome Justin Jean-Baptiste Maes, Eindhoven (NL); Gerardus Cornelis Petrus Lokhoff, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/544,827

(22) PCT Filed: Jan. 23, 2004
(86) PCT No.: PCT/IB04/50048

§ 371 Date: Aug. 5, 2005

(30) Foreign Application Priority Data
Feb. 10, 2003 (EP) 031002629

(51) Int. Cl. H04N 7/16; H04N 7/167; H04N 7/18

(52) U.S. Cl. 725/25; 725/31; 725/80; 725/74

(57) ABSTRACT

A method of and device for controlling import of content into a domain comprising a number of devices. The method comprises checking for the presence of a domain watermark in the content, and if the domain watermark is found in the content, refusing import of the content into the domain, and if the domain watermark is not found in the content, allowing import of the content into the domain and causing the domain watermark to be embedded into the content. Optionally, re-importing into the “original” domain might be allowed. In this embodiment the method further comprises refusing import of the content into the domain if the domain watermark is found in the content unless the identifier matches an identifier for the domain. Other payloads in the domain watermark can be used to e.g. implement location- or time-based restrictions on import.

The invention relates to a method of controlling import of content into a domain comprising a number of devices. The invention further relates to a device for controlling import of content into a domain comprising a number of devices.

Over the last 10 years, audiovisual content has started to become increasingly available in a digital (high quality) form. Examples are DVDs and digital television broadcasts (standard definition pay-TV but also high quality HDTV in the US). With the advent of digital content, came the specter of digital piracy—using the internet—with such exponents as the file-sharing systems as Napster and Kazaa. To combat this potential loss of revenues, new consumer devices such as players, recorders and Set Top Boxes process content whilst observing certain rules like:
this content may never be copied
this content may be copied one time
this content cannot be played back from a recordable disc

Usage rules of this kind are referred to as “copy protection”. In the near feature it is expected that more complex time-dependent and personalized rules will be supported:
this content can be played only 3 times
this content can be played for 72 hours
this content is only available to the devices of Mr. such-and-so

Rules of this kind are generally referred to as “Digital Rights Management”. In general it is the desire of the content owners (the record companies, movie studios, and sometimes broadcasters) that content which is sold to a particular person, can be enjoyed in his/her home, in accordance with the rules under which it was sold, that it can be consumed even on multiple devices, but that it should not travel beyond the limits of this home, or other domain. Sometimes this approach is called “Authorized Domains” (AD).

Current Copy Protection Mechanisms are a crude approximation to this AD, but DRM systems come already much closer. One cross-industry forum where ADs are being standardized is the DVB Copy Protection Technical module or DVB-CPT.

Proposed and existing implementations of the AD focus on encrypting content as soon as it enters the AD, or keeping it encrypted if it is introduced already in encrypted form. This serves two purposes:
1. When content is encrypted, it can only be consumed on devices that have access to the decryption key. So if all devices in a single AD share a common key, they can disseminate the content amongst themselves, but a device outside this AD has no access to it. An example of such a system is SmartRight, a proposal by Thomson Multimedia to DVB-CPT on November 2001 as DVB-CPT-714, see also http://www.smartright.org.
2. When the devices in an AD don't share an a priori common key, but establish one on a device-pair by device-pair basis, content distribution is still controlled because the license under which access is given to the key-establishment technology comes with so called compliance rules which force manufacturers to build their devices such that they cannot but obey the copy-control rules. 5C/DTCP, 4C/CPRM and xCP are examples of such systems. See for more information on these systems:
   Hitachi Corp., Intel Corp., Matsushita Electric Industries, Sony Corp., Toshiba Corp. (5C), “Protected Transport of Commercial Entertainment Content Using DTCP Technology”, submitted to DVB-CPT, November 2001 as DVB-CPT-717, http://www.dtcp.com.
   International Business Machines Corp., Intel Corp., Matsushita Electric Industries Corp., Toshiba Corp. (4C), “Content Protection for Recordable Media”, submission to DVB-CPT, November 2001 as DVB-CPT-712, http://www.4centity.com. International Business Machines Corp., “xCP Cluster Protocol”, submission to DVB-CPT, November 2001 as DVB-CPT-716.

Although such encryption systems control the content while inside the authorized domain they yield no protection once it is exported, e.g. for rendering on a TV or stereo-system. At this point, pirates can make a recording which can be distributed via the internet. For this fundamental problem—sometimes also referred to as the Analog Hole—there currently exists no all-encompassing solution.

However, some relief comes from the fact that, using watermarking technology, one can limit this leakage to just non-compliant devices, i.e. devices which are not already in an AD. Non-compliant devices encompass legacy devices such as VHS-recorders. When watermarking content, the content is marked with a specific noise pattern, which is invisible to the human eye or ear, and which is hard to remove without destroying the content itself but which can be detected with simple electronic circuitry or software. In such a system, the content owner or broadcaster watermarks the content before distributing it to the various ADs. When content eventually leaks, is copied, and a pirate tries to reintroduce it to an AD, a watermark detector in the AD notices the watermark in the content and refuses to admit it to the AD.

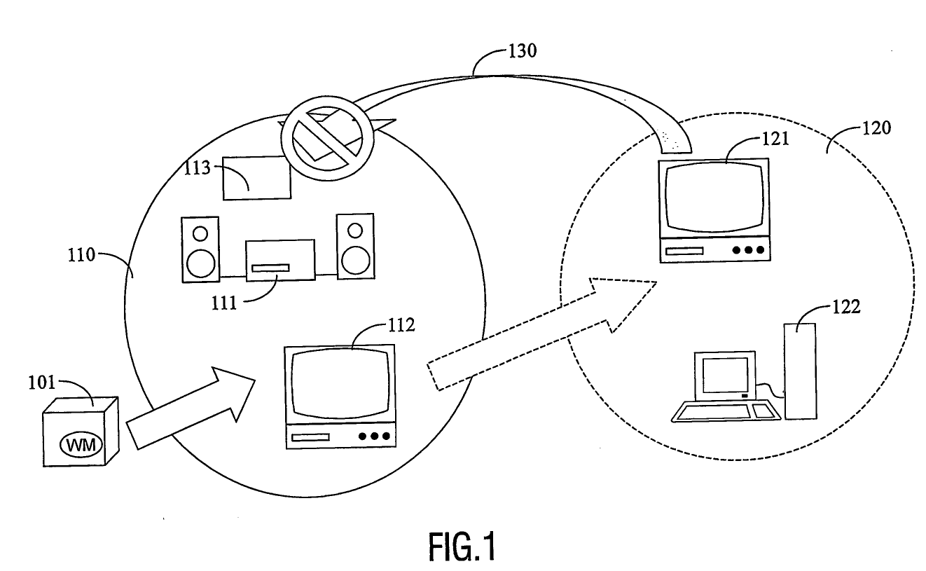

In FIG. 1, on the left, watermarked content 101 is consumed in an AD 110 comprising a number of devices 111, 112. These devices 111, 112 could be e.g. televisions or radio receivers, but also DVD audio and/or video players, personal computers, portable flash-based players, and so on. At some point the content 101 is rendered and leaks to the non-compliant world 120, with amongst others legacy devices 121, 122. When a pirate tries to reintroduce 130 the content into the AD 110, (s)he is stopped because a device 113 in the AD 110 detects that the supplied unencrypted content has been watermarked, signaling that it comes from outside the AD 110. The device 113 can be a dedicated import management device, but any device in the AD 110 can perform the watermark check before accepting any content.

A problem with this system is the first introduction of legitimate watermarked content into an AD, for how does a watermark detector in the AD distinguish this watermarked content from a legitimate source from that same watermarked content from an illegitimate source? A standard solution to this problem is to introduce the legitimate content only in encrypted form, e.g. through a Conditional Access (CA) system of a pay-TV operator or an server-based DRM-sale; since content is encrypted, the watermark is not visible. Pirates cannot abuse this channel because they cannot encrypt the illegitimate content with the right keys which the Set Top Box (STB) or Digital Rights Management (DRM)-application uses for decryption.

However this solution does not work for content such as so-called CCNA (Copy Control Not Asserted) content. This is digital publicly broadcast content, available to the public at no charge (usually sponsored by advertisement or government funding), which can be copied freely for personal use, but once received should not be distributed further. For example some of the terrestrial HDTV ATSC broadcasts in the United States have this status. Often such content is broadcast unencrypted because of legal restriction, but also some commercial pay-TV operators prefer not to encrypt their broadcasts, yet maintain control over copying.

It is an object of the present invention disclosure to provide a way of discerning the input of legitimate unencrypted content from illegally copied unencrypted content. It is noted that the above problem for digital CCNA-content also holds for other types of content, such as analog broadcast content, and the solution according to the invention is also suitable for such content.

This object is achieved according to the invention in a method comprising checking for the presence of a domain watermark in the content, and if the domain watermark is found in the content, refusing import of the content into the domain, and if the domain watermark is not found in the content, allowing import of the content into the domain and causing the domain watermark to be embedded into the content.

According to the invention, the system allows importing the content into a first domain, but prevents re-introduction of this content into a second domain, e.g. after rendering in the first domain and subsequent distribution of the recorded rendering over the Internet, by embedding the domain watermark into the content after importing into the first domain. The domain watermark may optionally contain an identifier of one or more domains, e.g. the domain in which the entity embedding the watermark resides.

Without any further measures, content once exported cannot be re-imported even on the devices on which it was originally imported. Optionally, re-importing into the “original” domain might be allowed. In this embodiment the method further comprises refusing import of the content into the domain if the domain watermark is found in the content unless the identifier matches an identifier for the domain.

The domain watermark can be embedded into the content when the content is being imported into the domain, or when the content is being exported from the domain. Checking for the presence of the domain watermark in the content is preferably done only if the content comprises a broadcast flag, is not in encrypted form, and/or comprises a particular (easy to detect) watermark.

In an embodiment the domain watermark contains location information such as a time zone or a region of the world, the method further comprising refusing import of the content into the domain if a location of at least one device in the domain does not match the location information. In another embodiment the watermark contains timing information, the method further comprising refusing import of the content into the domain if a current time does not match the timing information. These embodiments permit more sensitive control over when to refuse or allow import, e.g. time-based control (only before or after a certain point in time) or location-based control (only in a certain region or not in a particular region).

In another embodiment the method further comprises computing a robust hash and checking for the presence of the domain watermark in the content only if the computed robust hash occurs on a list comprising one or more robust hashes of content to be checked for the presence of the domain watermark. Using this list reduces the number of content items that need to be checked for the presence of the domain watermark.

In another embodiment the method further comprises allowing import of the content into the domain only if a license comprising a robust hash of the content is available.

It is a further object of the present invention disclosure to provide a device arranged for discerning the input of legitimate unencrypted content from illegally copied unencrypted content.

This object is achieved according to the invention in a device comprising a watermark detector for checking for the presence of a domain watermark in the content, coupled to an import control module, the import control module being arranged for, if the domain watermark is found in the content, refusing import of the content into the domain, and for if the domain watermark is not found in the content, allowing import of the content into the domain and causing the domain watermark to be embedded into the content.

In an embodiment the device further comprises a watermarking module for embedding the domain watermark into the content.

Further advantageous embodiments are set out in the dependent claims.

These and other aspects of the invention will be apparent from and elucidated with reference to the embodiments shown in the drawing, in which:

FIG. 1 schematically illustrates the concept of how unauthorized content import into a domain is restricted;

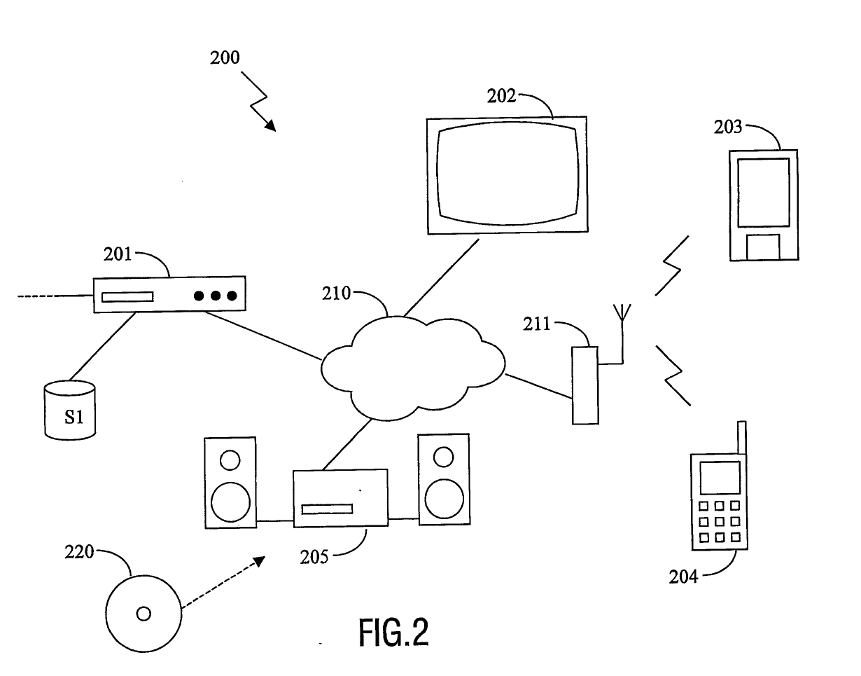

FIG. 2 schematically illustrates a system comprising devices interconnected via a network; and

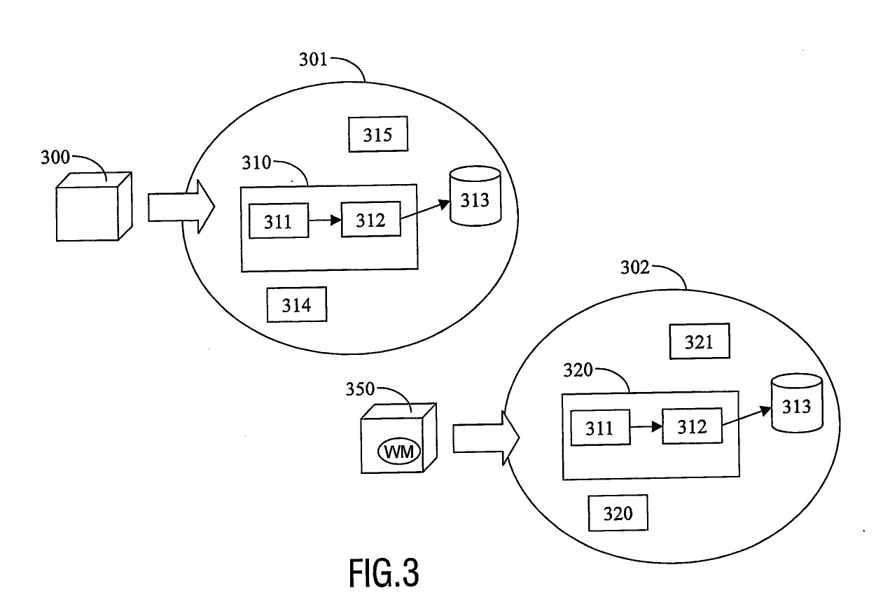

FIG. 3 schematically illustrates the process of content entering a screening device, part of an authorized domain.

Throughout the figures, same reference numerals indicate similar or corresponding features. Some of the features indicated in the drawings are typically implemented in software, and as such represent software entities, such as software modules or objects.

FIG. 2 schematically shows a system 200 comprising devices 201-205 interconnected via a network 210. In this embodiment, the system 200 is an in-home network. A typical digital home network includes a number of devices, e.g. a radio receiver, a tuner/decoder, a CD player, a pair of speakers, a television, a VCR, a tape deck, and so on. These devices are usually interconnected to allow one device, e.g. the television, to control another, e.g. the VCR. One device, such as e.g. the tuner/decoder or a set top box (STB), is usually the central device, providing central control over the others.

Content, which typically comprises things like music, songs, movies, TV programs, pictures and the likes, is received through a residential gateway or set top box 201. The source could be a connection to a broadband cable network, an Internet connection, a satellite downlink and so on. The content can then be transferred over the network 210 to a sink for rendering. A sink can be, for instance, the television display 202, the portable display device 203, the mobile phone 204 and/or the audio playback device 205.

The exact way in which a content item is rendered depends on the type of device and the type of content. For instance, in a radio receiver, rendering comprises generating audio signals and feeding them to loudspeakers. For a television receiver, rendering generally comprises generating audio and video signals and feeding those to a display screen and loudspeakers. For other types of content a similar appropriate action must be taken. Rendering may also include operations such as decrypting or descrambling a received signal, synchronizing audio and video signals and so on.

The set top box 201, or any other device in the system 200, may comprise a storage medium S1 such as a suitably large hard disk, allowing the recording and later playback of received content. The storage S1 could be a Personal Digital Recorder (PDR) of some kind, for example a DVD+RW recorder, to which the set top box 201 is connected. Content can also be provided to the system 200 stored on a carrier 220 such as a Compact Disc (CD) or Digital Versatile Disc (DVD).

The portable display device 203 and the mobile phone 204 are connected wirelessly to the network 210 using a base station 211, for example using Bluetooth or IEEE 802.11b. The other devices are connected using a conventional wired connection. To allow the devices 201-205 to interact, several interoperability standards are available, which allow different devices to exchange messages and information and to control each other. One well-known standard is the Home Audio/Video Interoperability (HAVi) standard, version 1.0 of which was published in January 2000, and which is available on the Internet at the address http://www.havi.org/. Other well-known standards are the domestic digital bus (D2B) standard, a communications protocol described in IEC 1030 and Universal Plug and Play (http://www.upnp.org).

It is often important to ensure that the devices 201-205 in the home network do not make unauthorized copies of the content. To do this, a security framework, typically referred to as a Digital Rights Management (DRM) system is necessary.

In one such framework, the home network is divided conceptually in a conditional access (CA) domain and a copy protection (CP) domain. Typically, the sink is located in the CP domain. This ensures that when content is provided to the sink, no unauthorized copies of the content can be made because of the copy protection scheme in place in the CP domain. Devices in the CP domain may comprise a storage medium to make temporary copies, but such copies may not be exported from the CP domain. This framework is described in international patent application WO 03/047204 (attorney docket PHNL010880) by the same applicant as the present application.

Regardless of the specific approach chosen, all devices in the in-home network that implement the security framework do so in accordance with the implementation requirements. Using this framework, these devices can authenticate each other and distribute content securely. Access to the content is managed by the security system. This prevents the unprotected content from leaking to unauthorized devices and data originating from untrusted devices from entering the system.

It is important that devices only distribute content to other devices which they have successfully authenticated beforehand. This ensures that an adversary cannot make unauthorized copies using a malicious device. A device will only be able to successfully authenticate itself if it was built by an authorized manufacturer, for example because only authorized manufacturers know a particular secret necessary for successful authentication or their devices are provided with a certificate issued by a Trusted Third Party.

In the embodiment of FIG. 3, content 300 enters a screening device 310, part of a first Authorized Domain 301, either through an unencrypted link or through an encrypted link. A watermark detector 311 checks for the presence of a watermark indicating that this content 300 has been inside an AD previously. If no such watermark can be found, a watermarker 312 is activated which embeds such a watermark in the content. The watermarker 312 could also be present in another device, for example one that is arranged to export the content 300 from the AD 301.

The now watermarked content then is available to other devices 314, 315 in the AD 301. For example, it could be stored on a hard disk 313 in or connected to the screening device 310 so that the other devices 314, 315 can gain access to the content 300.

If this content is presented to the AD 301 after a detour through the non-compliant world (e.g. a P2P file-sharing network), it is rejected because it already has an AD watermark, as would be detected by the watermark detector 311.

The content is then processed by the compliant member-devices 314, 315 of the AD 301 according to the usage rules, to which they are kept by e.g. encryption or license-based compliance rules, although watermark-based rules could also be employed. Thus copying within the AD 301 is allowed. The content 300 may at some point leave the AD 301, for example because it is recorded upon rendering using a handheld video camera or because it is written to a portable storage medium like a CD-R or DVD+RW disc. The exported content 350 bears the domain watermark WM. Note that this watermark WM could have been inserted by the device performing the export operation instead of by the screening device 310, or by any other device in the AD 301.

The exported watermarked content 350 is introduced to a screening device 320 in a second Authorized Domain 302, e.g. by recording the rendering with a video camera. The watermark WM indicates to the AD access-devices 320, 310 that the content has to be rejected because it was already present in an AD in the past; i.e. it reached its destination previously and the current introduction must be illegal. The screening device 320 operates in a manner comparable to screening device 310.

Because watermark detectors can be expensive (depending on the way content is represented, i.e. the kind of compression), a practical refinement would be if only certain classes of devices checked for a watermark, e.g. recorders. This way no separate screening devices 320 are necessary.

If the content is CCNA-content and should be treated as such, then a signaling means is typically provided in the content, such as for instance a broadcast flag or a broadcast watermark, or other signaling means known in the art. The watermark detector 311 should only be activated if it has been established that the content is CCNA-content. A CCNA detector can be provided to establish this.

Sometimes CCNA-content is distributed over different broadcast channels simultaneously, e.g. it is sent via terrestrial broadcast unencrypted to some ADs and also via satellite encrypted to other ADs. To keep the system consistent, the second AD 302 also has to watermark the CCNA-content. This is often impractical, since it involves extra encryption and decryption steps to enable this watermarking. This can cause undesired delays, and en/decryption keys are not always available in all devices. Alternatively the invention therefore proposes to also allow this watermarking of encrypted CCNA-content:
in another member-device of the AD which can en/decrypt at a later stage, but before rendering/export from AD, or
right after decryption for rendering. While encrypted in the AD, the watermark-status of the content doesn't really matter, because that status-information is really carried by the encryption-status, or associated DRM licenses. Only after decryption does the content leave the AD, its status should be immediately transferred to the watermark domain.

An important issue is the handling of legacy devices. People's home-networks will not be converted to ADs overnight. E.g. many people own large expensive HDTVs or big-screen TVs, with just analog inputs. For some time to come home networks will be mixtures of such devices and new compliant AD devices. CCNA-content absorbed into such a mixed AD will constantly leave and re-enter the AD in legitimate use although it never actually left the home. The embodiments described above will unreasonably reject content after it left the AD the first time.

In a further embodiment, the above situation can be improved by assigning every AD an ID-number, which is preferably globally unique. Furthermore, the watermark embedded by the watermarker into the content has a payload reflecting this ID-number. Thus a watermark detector in an AD-device can verify whether it is about to import content which left, and returned to the same AD (allowed) or content from some other AD.

Moreover, this ID-number can be used for tracing purposes if this content ends up being publicly available, e.g. on a file server.

A practical issue is that there will potentially be millions of ADs, whereas the payload of hard-to-remove watermarks is usually limited to a few bits. Although time multiplexing small payloads into large payloads might help, this is not preferred because content can be split into parts, reordered, sped up or slowed down etc. during playback, making re-assembly of the original ID-number difficult. However for the present invention's use of the watermark, i.e. making re-import in different ADs more difficult, a system with relatively small ID-numbers already provides reasonable comfort. Imagine e.g. a system where the ID-number is 10-bits (i.e. 1,024 possible ID-numbers, so many ADs will in fact share the same ID-number). This means that an internet-based P2P server system would have to keep not just 1 but rather 1024 copies of a piece of content on-line, in order to accommodate the 1024 possible ID-numbers that a downloading AD might have.

Another method to control importing unencrypted content into an AD known e.g. from SDMI (Secure Digital Music Initiative, http://www.sdmi.org), works as follows: content is watermarked with as payload a unique identifier. It is subsequently distributed in encrypted form, in which way it can be imported into ADs in a controlled manner. When it gets decrypted and is reintroduced into an AD, the watermark detector in an AD access-device detects the watermark and responds by requiring that the user obtain a (DRM) license to import this content via some digital back-channel: e.g. buy this license on a web-site, or register with some clearing-house. The organization delivering the digital license (the web-site, or the clearing-house in the previous examples), knows which content is to be licensed, because of the unique content-identifier in the watermark-payload.

In this system, the control over importing is delegated to an external licensing authority, which keeps track of what is imported when and where. Although probably impractical in the short run, this type of architecture is very popular with content owners because it comes very close to being able to charge people for every time they access content.

A practical problem with this system is that the payload of watermarks is limited, making unique identification of the content to be important difficult. The invention proposes that rather than using the payload of a watermark, the content is characterized by its robust audio or video hash, sometimes also called (robust) fingerprint.

For an example of an audio fingerprinting method, see Haitsma J., Kalker T., Oostveen J., “Robust Audio Hashing for Content Identification”, Content Based Multimedia Indexing 2001, Brescia, Italy, September 2001.

For an example of a video fingerprinting method, see Oostveen J., Kalker T., Haitsma J., “Feature Extraction and a Database Strategy for Video Fingerprinting”, 5th International Conference on Visual Information Systems, Taipei Taiwan, March 2002.

Published in “Recent Advances in Visual Information Systems”, LNCS 2314, Springer, Berlin pp. 117-128.

There are two ways to trigger the hashing/fingerprinting of content to obtain a license:
1. all unencrypted content to be imported into an AD is subjected to robust hashing, or
2. a watermark in the content signifies that this content requires a DRM license, where the content can be identified from a robust fingerprint.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. A method of controlling import of content into a domain comprising a number of devices, comprising checking for the presence of a domain watermark in the content, and
if the domain watermark is found in the content, refusing import of the content into the domain,
if the domain watermark is not found in the content, allowing import of the content into the domain and causing the domain watermark to be embedded into the content.

2. The method of claim 1, in which the domain watermark is embedded into the content when the content is being imported into the domain.

3. The method of claim 1, in which the domain watermark is embedded into the content when the content is being exported from the domain.

4. The method of claim 1, in which the domain watermark contains an identifier of one or more domains.

5. The method of claim 4, comprising refusing import of the content into the domain if the domain watermark is found in the content unless the identifier matches an identifier for the domain.

6. The method of claim 1, in which the domain watermark contains location information such as a time zone or a region of the world, the method further comprising refusing import of the content into the domain if a location of at least one device in the domain does not match the location information.

7. The method of claim 1, comprising checking for the presence of the domain watermark in the content only if the content comprises a broadcast flag.

8. The method of claim 1, comprising checking for the presence of the domain watermark in the content only if the content comprises a broadcast flag and is not in encrypted form.

9. The method of claim 1, comprising checking for the presence of the domain watermark in the content only if the content comprises a particular further watermark.

10. The method of claim 1, comprising computing a robust hash and checking for the presence of the domain watermark in the content only if the computed robust hash occurs on a list comprising one or more robust hashes of content to be checked for the presence of the domain watermark.

11. The method of claim 1, in which the watermark contains timing information, the method further comprising refusing import of the content into the domain if a current time does not match the timing information.

12. The method of claim 1, comprising allowing import of the content into the domain only if a license comprising a robust hash of the content is available.

13. A device for controlling import of content into a domain comprising a number of devices, comprising
a watermark detector for checking for the presence of a domain watermark in the content, coupled to an import control module,
the import control module being arranged for,
if the domain watermark is found in the content, refusing import of the content into the domain, and
if the domain watermark is not found in the content, allowing import of the content into the domain and causing the domain watermark to be embedded into the content.

14. The device of claim 13, further comprising a watermarking module for embedding the domain watermark into the content.
